(19) United States
(12) Patent Application Publication
(10) Pub. No.: US 2007/0226080 A1
(43) Pub. Date: Sep. 27, 2007

(54) Method and system for linking customers and vendors

(75) Inventor: Cary Chessick, Arlington Heights, IL (US)

Correspondence Address: SEYFARTH SHAW LLP, 131 S. DEARBORN ST., SUITE2400, CHICAGO, IL, 60603-5803, US

(73) Assignee: Restaurant.com, Inc.

(21) Appl. No.: 11/408,361

(22) Filed: Apr. 21, 2006

Related U.S. Application Data
(63) Continuation-in-part of application No. 11/371,031, filed on Mar. 8, 2006.

(51) Int. Cl. G06Q 30/00

(52) U.S. Cl. 705/27

(57) ABSTRACT

A method and apparatus are disclosed for facilitating and linking a vendor with a customer desiring the vendor's goods and/or services. A customer contacts a remotely located system, requests information, and responds to this information by inputting a request to the remote system. This request includes information regarding, e.g., a reservation for the vendor's services. The remote system contacts the vendor and seeks acceptance of the request. Upon acceptance by the vendor, the remote system contacts the customer, either via email and/or telephone, to provide confirmation. If the request is rejected, the remote system may attempt to establish a connection between the customer and vendor, preferably a telephonic connection allowing voice communications. During connection with either the vendor or the customer, announcements and/or advertisements may be played.

### CROSS-REFERENCE TO RELATED APPLICATION(S)

This is a continuation-in-part application of U.S. patent application Ser. No. 11/371,031, filed Mar. 8, 2006, titled “Method and System for Linking Customers and Vendors,” the entirety of which is incorporated herein by reference.

### FIELD OF THE INVENTION

The invention relates to a system and method for introducing multiple parties, in particular, for introducing a consumer of goods or services and a vendor who provides those goods and services and, more particularly, for linking in direct communication a restaurant and a potential customer for the restaurant.

### BACKGROUND

Currently, there are many different ways in which a vendor who provides goods or services attempts to attract a customer, and there are many ways in which a customer identifies those vendors that seem appealing or suiting to their needs. For example, a diner may simply wander an area that has a number of restaurants and select one that appears to offer the atmosphere and fare that the diner desires. To attract the diners as customers restaurants may display their menus out front and have windows allowing the diners to see into the restaurant. Diners may also rely on word of mouth, and a recent practice has been for restaurants to send people out to other bars or restaurants to talk up their establishment in an attempt to create a fad appeal or buzz.

Typically, people tend to resist simply setting out on a hunt for a restaurant without some basis for selecting the desired area. Often, people would rather look in a directory, such as a phone book for a restaurant serving, e.g., Chinese food or steak.

With the increased development and utility of the internet as a source of information gathering, people have come to rely, at least in part, on surfing the web as a means for identifying a restaurant. One of the difficulties, however, is locating a reliable directory. The internet is seen as a source for collecting information that allows a consumer to make fully informed choices. As such, people would rather go to a site that lists all the products or service providers available, and then consider the relative merits of each for themselves. Finding such a directory for identifying restaurants can be difficult, though not impossible.

Many such directories are operated by a network which has a broader goal of identification of entertainment choices, including movies, theater, bars, bowling alleys, art gallery and museum events, charity events, or summer festivals. For instance, the website of a daily newspaper, The Chicago Tribune, includes a site called Metromix which includes concerts, bars and restaurants, spas and gyms, and events, among other features. The site is principally driven by advertising revenues such that the listings are based on paying for the listing. The listings will typically include a telephone number if one would like information or, more specifically, would like to make a reservation. Some listings will include a link to a separately hosted website specific to a restaurant or the like, which typically will have a phone number for making a reservation.

Some restaurants have separately hosted websites. These may rely simply on a broad keyword search or on a listing such as the yellow pages feature of Yahoo!™, found on the internet at yahoo.com. Again, these restaurants typically give a phone number for making a reservation. Other times, these restaurants may have their own online reservation system.

Existing online reservation systems tend to be unreliable for a consumer or diner. For instance, if a diner requests a table for four, to be seated at 6:30 p.m. on a Thursday night, that information can be input to the restaurant's online system. However, if the restaurant personnel has fielded one or more telephone calls, or otherwise accepted reservations, without the online system's database being up-to-the-minute accurate, there will be a problem with attempting to honor the reservation. Maintaining the database with such accuracy is labor-intensive. To compound this fact, the diner who has received a confirmation of the reservation may not be reachable when the restaurant realizes the overbooking. At times, diners will presents themselves and their party to the restaurant at the appointed time only to discover their reservation will not be honored, or that they will have to wait an extended period of time. Other dining options may not be available nearby, or the extended wait to be seated may complicate further evening plans, such as theater tickets.

There are many other venues or arenas that potentially suffer the same difficulties. For instance, finer salons and spas typically require appointments. Golf courses, including public and municipal golf courses, require tee-times. Auto service shops, such as oil change companies and stereo installation services, often schedule appointments and service times.

It is clear that use of the internet benefits consumers and businesses alike. By presenting textual data, the likelihood of communication error is greatly reduced so that accuracy in what is sought is increased. The utility of the internet for easily presenting to potential customers business particulars, such as pricing, menus, or interior views of the establishment, is unparalleled. However, there is still a need for an improved system and method for vendors and customers, such as restaurants and diners, to make arrangements such as dining reservations.

### SUMMARY

In accordance with an aspect, a system for facilitating a relationship between a vendor and a potential customer for the vendor is disclosed, the system being located remotely from the vendor and the customer. The system includes at least one customer communications connection permitting the customer to connect to the system, to retrieve data from the system, and to input data including a request to the system, an information retrieval function for collecting information in response to a request by the customer, an information delivery function for sending the collected information to the customer, an information record function for storing information input including the request by the customer, at least one vendor communications connection for connecting to the vendor, and for sending information including the request to the vendor, an information record function for storing input including a response to the request by the vendor, a confirmation communication function to deliver a vendor confirmation to the customer request, and a connection function between the customer communications connection and the vendor communications connection allowing the vendor to communicate with the customer if the vendor response is not a confirmation of the customer request.

The customer communications connection of the system may include an internet capability permitting the customer to access the system, retrieve data from the system, and input data to the system via the internet. The customer communications connection may include a telephonic connection allowing the system to connect with the customer via telephone.

The system may include a database of information, and the information retrieval function collects information from the database for sending to the customer. The information retrieval function may collect information from an internet site based on the database information.

The vendor communications connection preferably includes a telephonic connection for sending information to the vendor, and the connection function allows the vendor to speak with the customer via the telephonic connection. The customer communications connection and the vendor communications connection preferably include respective telephonic connections and the connection function includes a call function for calling, via the respective telephonic connections, the vendor and customer. The data input by the customer may also include a time to be contacted, if necessary.

The system also may include a message play function including an announcement function for addressing the customer and the vendor when each is respectively contacted via telephonic connections. The message play function may include an advertisement function for playing advertisements. The advertisements may be played to the vendor and/or customer, and may be played once a call is answered. The advertisements may be played to the vendor while the customer is being called.

In another aspect of the invention, a method is provided facilitating a relationship between a vendor and a potential customer. The method may include providing a remotely located system, permitting the customer to access information via the remote system, permitting the customer to input data including a request to the remote system, storing at least the request of the customer input data in the remote system, connecting with the vendor, and providing the customer request to the vendor. The method may include receiving information from the vendor including a response to the request. The method may include connecting the vendor with the customer if the response does not include a confirmation of the request. The method may include the remotely located system providing an automated confirmation message if the vendor response includes a confirmation, and the confirmation message may be via the customer telephonic connection and/or via electronic mail.

The method may include providing at least a portion of the customer input data to the vendor. The customer input data may include a request for a reservation, and/or a non-reservation request.

The method may further include a step of retrieving information in response to the customer input data, and a step of sending a portion of the retrieved information to the customer. The retrieving of information may include accessing information stored in the remote system, and accessing information from the internet.

The method may include connecting with the vendor by making a telephonic connection with the vendor. The vendor may then confirm the customer request by following response instructions. If the vendor is unable to confirm the customer request, the vendor may choose to connect to the customer. The method may further include connecting the vendor with the customer by making telephonic connections with each of the customer and vendor to permit voice communications therebetween. The method may include playing an advertisement via at least one telephonic connection, such as during the making of another telephonic connection.

In a further aspect, a method for facilitating arrangement of a reservation between a diner and a restaurant is disclosed. The method may include providing a remotely located system, permitting the customer to access information regarding at least one restaurant via the remote system, sending information regarding at least one restaurant to the customer from the remote system, receiving data input by the customer to input data into the remote system, connecting the remote system with the restaurant, and providing one or more telephonic connections for the vendor and customer.

The method may include storing at least a portion of the input data from the customer, and may include sending at least a portion of the input data from the customer to the restaurant. This portion of the input data may be sent to the restaurant via a telephonic communication. The customer input data may include a request for a reservation, and/or a non-reservation request.

The method may include retrieving information in response to the customer input data, and a step of sending a portion of the retrieved information to the customer. Retrieving the information may include accessing information stored in the remote system, and may include accessing information from the internet.

Providing a telephonic connection includes making a telephonic connection to permit voice communication. This may include making telephonic connections with each of the diner and the restaurant to permit voice communications therebetween. Once the telephonic connection is made between the system and either or both of the diner and restaurant, the method may include playing audio advertisements or other announcements.

In a further aspect, a computer implemented system operating under control of a stored program for facilitating a relationship between a vendor and a potential customer for the vendor and being located remotely from the vendor and the customer is disclosed. The program includes a customer communications connection portion permitting the customer to connect to the system, to retrieve data from the system, and to input data to the system, an information retrieval function portion for collecting information in response to request by the customer, an information delivery function portion for sending the collected information to the customer, an information record function portion for storing information input by the customer, at least one vendor communications connection portion for connecting to the vendor, and for sending information to the vendor, a response function portion for receiving from the vendor a response regarding the information sent to the vendor, and a confirmation function for providing the vendor response to the customer.

The response function portion may include a prompt function portion providing response instructions and requesting a response in accordance with the response instructions. The vendor response may include acceptance of the customer request. The system may include a confirmation function for providing confirmation of acceptance of the customer request by the vendor. The confirmation function may include an electronic mail function, and may include a telephonic function for telephoning the customer to provide confirmation of acceptance. The customer input data may include a time to be telephoned, and the telephonic function may be operated at the time to be telephoned to provide confirmation of acceptance.

The vendor response may include input other than a confirmation of the customer request, such as input indicating the vendor is unable to confirm the request. The system may include a connection function portion between the vendor communications connection and the customer communications connection allowing the vendor to communicate with the customer, the system connecting the vendor and customer when the vendor does not provide a confirmation, such as if the vendor rejects the request or is otherwise unable to confirm the customer request. The customer communications connection portion may include an internet capability permitting the customer to access the system, retrieve data from the system, and input data to the system via the internet. The customer communications connection portion further may include a telephonic connection allowing the system to connect with the customer via telephone. The customer communications connection portion and the vendor communications connection portion may include respective telephonic connection portions and the connection function portion includes a call function portion for calling, via the respective telephonic connection portions, the customer and vendor. The system may include a message play function portion including an announcement function portion for addressing the customer and the vendor when each is respectively contacted via the telephonic connection portions. The message play function portion may include an advertisement function portion for playing advertisements to the vendor while contacting the customer via the telephonic connection portion.

In another aspect, a method for facilitating arrangement of a reservation between a diner and a restaurant is disclosed including providing a remotely located system, permitting the customer to access information regarding at least one restaurant via the remotely located system, sending information regarding at least one restaurant to the customer from the remotely located system, receiving data including reservation information input by the customer to input data into the remotely located system, connecting the remotely located system with the restaurant, communicating the input customer data to the restaurant, receiving a response to the input customer from the restaurant, and sending a response communication to the customer based on the restaurant response. The step of receiving a response may include receiving a non-confirmation response or a rejection response from the restaurant. The step of sending a response communication may include notifying the diner of the non-confirmation response or rejection response from the restaurant. The step of notifying the diner may include sending an email to the diner. The step of notifying the diner may include telephoning the diner. Telephoning the diner may include telephoning the restaurant and connecting the diner with the restaurant, and may include playing audio advertisements. The customer input data may also include a non-reservation request.

### BRIEF DESCRIPTION OF THE DRAWINGS

FIG. 1 is a functional block diagrammatic representation of a system for linking a customer with a vendor of goods and/or services including a customer-use system, a vendor-use system, and a remote-use system;

FIG. 2 is a representation similar to FIG. 1 of a system for linking a diner with a restaurant including a diner-use system, a restaurant-use system, and a remote-use system;

FIG. 3 is a functional block diagrammatic representation of the remote-use system of FIG. 2 showing the components thereof;

FIG. 4 is a flowchart representing methods of operating the linking systems of FIGS. 1 and 2; and

FIG. 5 is a flowchart representing additional methods of operating the linking system of FIGS. 1 and 2;

### DETAILED DESCRIPTION

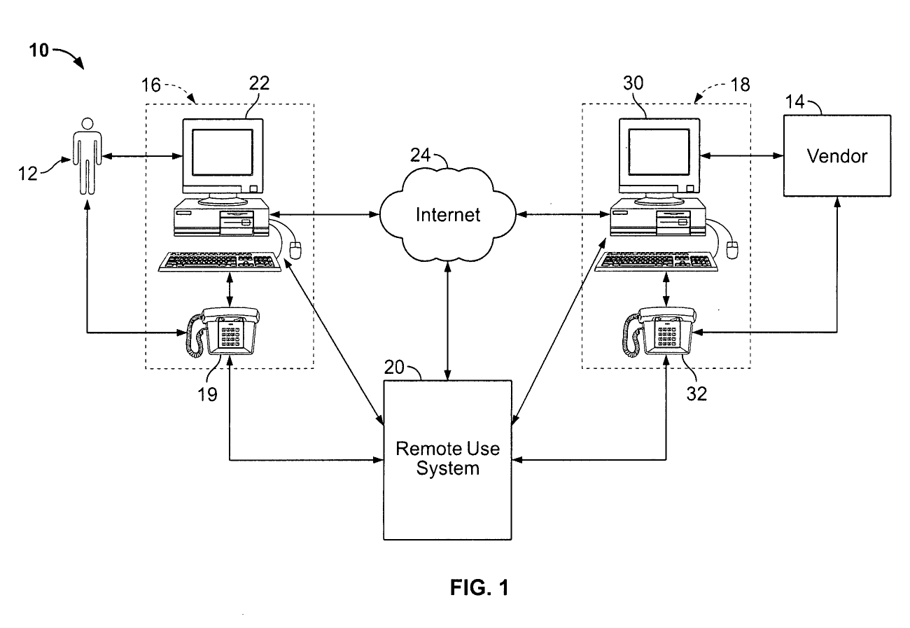

Referring initially to FIG. 1, a system 10 for linking a customer 12 and a vendor 14 of goods and/or services is depicted. The system 10 includes a customer-use system 16 with which the customer 12 inputs and receives information, and a vendor-use system 18 with which the vendor 14 receives and returns information. The system 10 further includes a remote-use system 20 with which the customer 12 initially communicates, and which provides one or more communications connections with the customer 12 and the vendor 14.

The customer 12 utilizes the customer-use system 16 to establish a communications connection with the remote-use system 20. The customer 12 requests information from the remote-use system 20, which replies with information tailored to the specific request of the customer 12. After one or more exchanges of information between the customer 12, via the customer-use system 16, and the remote-use system 20, the remote-use system 20 then establishes a communications connection between itself and the vendor 14 via the vendor-use system 18. The remote-use system 20 may utilize one or more communications connections both with the customer 12 and with the vendor 14.

In a preferred form, the customer-use system 16 includes a personal computer 22 that establishes a communications connection with the remote-use system 20 via the internet 24. The customer 12 utilizes the computer 22 to request information regarding one or more vendors 14 from the remote-use system 20, i.e., from a website associated with the remote-use system 20. The remote-use system 20 either stores the information regarding the vendors 14 locally, or retrieves the information from the internet where various vendors 14 have separately hosted websites, for instance, or directly from the vendor-use system 18. The remote-use system 20 then delivers the information to the personal computer 22 for display to the customer 12. The customer 12 may make subsequent requests for information, and the remote-use system 20 will continue to deliver whatever is requested.

At some point, the customer 12 may make a selection of a particular vendor 14. To do so, the customer 12 provides an input indication to the personal computer 22 that is delivered to the remote-use system 20. The customer 12 may make the indication by directly communicating selection of a particular vendor 14, and then be asked to input data specific to information for transmittal of that information to the vendor 14, or the customer may simply input specific information fields, such as a date on which services are to be received, in order to communicate a selection of a vendor 14. In any event, the personal computer 22 and the remote-use system 20 send and receive information that prompt the customer 12 to input specified information necessary to the vendor 14.

Once the information is collected, the remote-use system 20 attempts to deliver the information to the vendor 14. The vendor-use system 18 may include a computer 30 system for providing the information originally requested by the customer 12, such as a locally-hosted website, and for receiving the information provided by the customer 12 via the remote-use system 20. The vendor-use system 18 may also or alternatively include a telephonic terminal 32 for receiving the information. The remote-use system 20 may also attempt to establish a connection between a telephone 19 of the customer 12 and telephone 32 of the vendor 14, as will be discussed below.

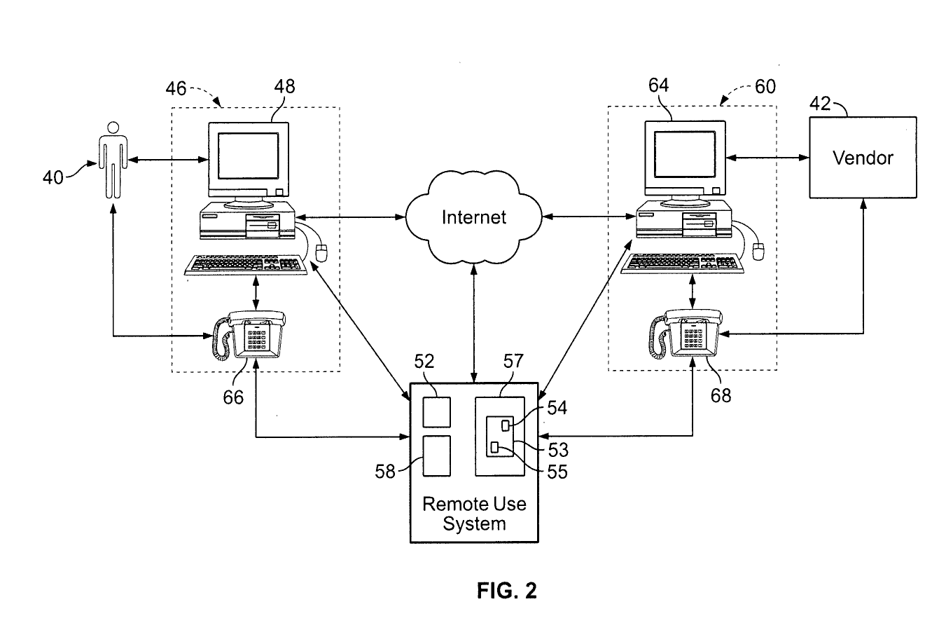

In one embodiment of a method of the invention depicted in FIG. 2, the customer 12 is a diner 40 seeking to identify restaurants that will accommodate the needs of the diner 40, and the vendor 14 is a restaurant 42 selected from among a group of restaurants. In a specific use of the system 10, the diner 40 is seeking to identify a particular restaurant and make a reservation for that restaurant.

The diner 40 uses a diner-use system 46 including a personal computer 48 to communicate with a remote-use system 50 via the internet. The diner 40 inputs various information to create search parameters. These parameters may include a particular area or location, based on city, zip code, or proximity to a street address; may include type of fare, such as Chinese, vegetarian, sushi, for instance; may include acceptance of certain pay forms, such as particular credit card companies; or a number of other criteria. The remote-use system 50 may include a database 52 including information relevant to the search parameters for a number of restaurants, or may access these from other sources, such as a computer 64 of a restaurant-use system 60, via the internet. The database 52 may also include record files for each restaurant, including telephone numbers, menus, pricing, and biographical information such as a marketing description of the restaurant, its clientele, its personnel such as owner or executive chef, and its atmosphere including photo images of the interior and exterior. The diner 40 then may make a selection of the restaurant 42, as described above.

In response to the selection, the remote-use system 50 requests information from the diner 40 in a textual manner, or displays drop-down menus or check boxes on the computer 48 of the diner 40, allowing accurate input of the information. For instance, a date for the reservation may be made by clicking on a calendar displayed on the computer 48, the time may be selected by clicking on a clock or drop-down menu that has available times in predetermined increments, the number in the dining party may be input by a second drop down menu, and check boxes may be provided for such things as smoking/non-smoking seating, peanut allergy, or other pre-determined common criteria. The remote-use system 50 may query, or accepts as input, a time at which the diner 40 would like to be contacted for confirmation/arrangement of the reservation, or as otherwise necessary. The time at which the diner 40 would like to be contacted may be immediately or in a matter of minutes, hours, or days.

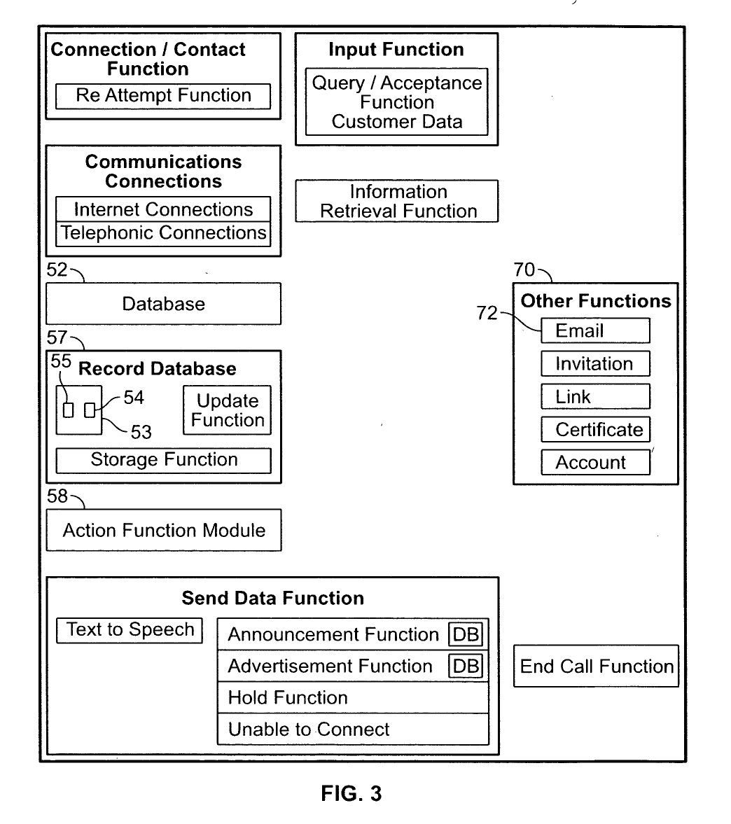

Referring also to FIG. 3, the remote-use system 50 saves the information as a record 53, typically a reservation record 54, in a database 57. The database 57 includes mapping information based on the zip code of the restaurant, and the records 53 are mapped in the database 57 according to such zip code information. The remote-use system 50 includes an action module 58 which surveys the database 57 for new records 53. The record 53 typically includes a name for the diner 40, a number of people for which the reservation is to be made, a date and time for the reservation, a phone number of the diner 40, and an email address for the diner 40.

When the remote-use system 50 finds a new record 53 the system attempts to contact the restaurant 42. As an example, Asterisk PBX software may be incorporated into the remote-use system 50, and the Asterisk software may be utilized to call the restaurant 42 (or diner 40, as discussed herein), and may be used to monitor the database 57 for new records 53 and reservations 54. The restaurant 42 is provided the request of diner 40. The restaurant 42 then responds according to response instructions provided by the remote-use system 50. If the restaurant 42 is able to confirm the request of the diner 40, then the call is ended and the diner 40 is contacted via telephone 66 and/or electronic mail to personal computer 48. If the restaurant 42 is unable to confirm or rejects the request of diner 40, then the restaurant 42 may choose for the remote-use system to connect the restaurant 42 with the diner 40 via telephone 66.

In greater detail, the remote-use system 50 recognizes receipt of the diner's information and creation of the record 53 and thereupon immediately places a call to the restaurant 42. The remote-use system 50 checks for an answer by the restaurant 42 and updates the record 53 to note that an attempt was made to contact the restaurant 42. If there is an answer, the remote-use system 50 confirms that the answer is by a person and not by a voicemail account. If the answer is voicemail or there is no answer, the remote-use system 50 updates the record 53, and disconnects. The remote-use system 50 will then check to see if an additional attempt should be made and when. If an additional attempt is not to be made, the remote-use system 50 provides a message to the diner 40, either via telephone or via email, that the remote-use system 50 was unable to confirm the reservation, and the database 57 is updated to record this information.

Once the remote-use system 50 is able to connect with a live person at the restaurant 42, an announcement is played to that person. The announcement identifies the purpose of the call, and may also play an advertisement, as discussed above. The announcement may be tailored to the specific restaurant 42 or to a category of restaurants 42. For instance, all restaurants that are commonly owned or affiliated in some way may receive one of a particular set of announcements, while others may receive one of another set of announcements. During the call, and without calling the diner 40, the remote-use system 50 will convey the information about the reservation to the restaurant 42. Once the information is presented, the remote-use system 50 allows the restaurant 42 a short period of time to make a determination as to the acceptability of the reservation. Two or more prompts or options are provided to the restaurant 42 for responding, such as a confirmation of the reservation or a non-confirmation (i.e., a rejection) of the reservation. This may be accomplished by allowing spoken responses and voice-to-data conversion of the response, such as “yes” or “no.” Alternatively, the restaurant 42 may be prompted to key in a response, such as by pushing a particular telephone button or buttons. As examples, the restaurant 42 may confirm or reject the reservation by pressing or saying a particular confirmation code with the telephone keypad, pressing or saying “1” or “2,” or saying “yes” or “no.” There may also be a set of particular codes so that the restaurant may provide other information, such as categorically rejecting all reservations on a particular day.

If the reservation is accepted, the record 53 is updated, and the remote-use system 50 may either call the diner 40 at a designated time to confirm, and/or preferably simply sends an email confirmation to the diner 40, or may call the diner 40 at any time and leave a automated voicemail in a voice mailbox of the diner 40. More preferably, the diner 40 is able to make a selection at the time of providing their desired reservation information as to a preference for the manner or mode the confirmation is provided.

If the reservation is rejected, the record 53 is again updated. The remote-use system 50 may immediately attempt to contact the diner 40 to indicate that confirmation was not achieved for the reservation, either through a telephonic connection and/or via email. Preferably, the restaurant 42 is on hold and receives advertisements during this time. If the diner 40 does not answer, or voicemail answers, a message is played to the restaurant 42 indicating that the diner 40 cannot be reached at that time, whereupon the remote-use system 50 disconnects from the restaurant 42. Prior to disconnecting from the restaurant 42, the remote-use system 50 may provide the restaurant 42 the telephone number that the diner 40 provided, or the diner's email address, so that the restaurant 42 can independently attempt contact with the diner 40. The diner 40 may opt-in or opt-out of such a feature. If the diner 40 does answer, an announcement is played which may include an advertisement or marketing message, may indicate the reservation is not confirmed, and may indicate that a connection will be made with the restaurant 42. The diner 40 and restaurant 42 are then connected.

Alternatively or in addition, the remote-use system 50 may consider a time the diner 40 has designated for being contacted. The remote-use system 50 may, at that time, try to connect with the diner 40 and with the restaurant 42. However, once successfully connecting with the diner 40, the remote-use system 50 informs the diner 40 that the reservation was rejected, and requests that the diner 40 holds while the remote-use system 50 attempts to connect with the restaurant 42 so that the diner 40 and restaurant 42 may communicate in real time to agree on a reservation. In the event code categories are provided, the restaurant 42 may have already communicated to the remote-use system 50 that no reservation would be possible on the particular day, and this information may be played to the diner 40. In response to this information, the diner 40 may continue to hold while the call is being played, or may override the remote-use system 50 by inputting a disconnect or abort code. As discussed herein, advertisements or other information may be played to the diner 40 and/or restaurant 42 during the course of the telephone calls. At each appropriate step, the record 53 may be updated to memorialize what transpired, as well as to memorialize what announcements and advertisements were played.

In order to connect the remote-use system 50 with either or both of the restaurant 42 or the diner 40, and for the remote-use system 50 to connect the restaurant 42 with the diner, two conditions should be met. Specifically, the diner 40 and/or restaurant 42 must respond to the remote-use system 50, and preferably do not respond with a voice mailbox. For the diner 40 and the restaurant 42, once the connection has been established by the remote-use system 50, the remote-use system 50 determines whether the answer is a voice mailbox. If a voice mailbox is reached for the diner 40, such as if the restaurant 42 rejected or were unable to confirm the reservation request, the restaurant 42 is informed that the diner 40 is not available, and the record 53 in the database 57 is updated to indicate contact was unsuccessful. The remote-use system 50 may be programmed to re-attempt contacting the diner 40, such as in a short period of time and/or may attempt to leave a message with the voice mailbox. If the diner 40 is reached, the remote-use system 50 then connects the diner 40 to the restaurant 42.

When a call is answered, the remote-use system 50 first identifies itself as the telephone connection of the reservation system the diner 40 used on-line. Next, the remote-use system 50 may play advertisements. For the diner 40, the advertisements may be based on the telephone area code from which the diner 40 is being called or may be based on a location for the restaurant 42 at which they are attempting to make a reservation. By way of example, the advertisement may describe restaurants or other business located in the area of the diner 40, or may be a theater or parking garage near where the restaurant 42 is located. The advertisement may also include information regarding the company who is providing the services of the remote-use system 50, and/or general advertisement such as for national brands. For the restaurant 42, the advertisements may be for products, or services, or vendors in which the restaurant 42 may be interested, or for business associations or promotional opportunities, for example. Preferably, a number of advertisements are rotated or chosen at random to be played. Between advertisements, a message indicating that the remote-use system 50 is still making a connection may be played, such as a “continuing to hold” message.

When the restaurant response to the reservation request indicates that the restaurant 42 is unable or unwilling to confirm the reservation, the remote-use system 50 notifies the restaurant 42 that the diner 40 is being connected to the restaurant 42 to discuss, arrange, and confirm a reservation. At that time, the diner 40 and the restaurant 42 are connected so that the two parties may speak directly, though the communication is still routed through the remote-use system 50.

Preferably, the remote-use system 50 limits the conversation time to five minutes. At four minutes and forty-five seconds, the remote-use system 50 indicates that the call will be ended in fifteen seconds. Within that time frame, it is believed that the diner 40 and restaurant 42 should have suitably communicated the necessary information, including an exchange of telephone numbers should the parties need to communicate further.

It should be noted that the ability of the remote-use system 50 to recognize information input from either the restaurant 42 or the diner 40 is not limited to, for instance, acceptance of a reservation, or rejection thereof. More pointedly, it should be emphasized that features normally associated with automated telephony-based systems may be present in the remote-use system 50, such as the ability to replay a message or announcement, to rewind a portion of the announcement, to skip ahead in the announcement, to end the call (including simply hanging up), and to direct the remote-use system 50 not to call again. It should also be noted that the telephony features and email capabilities of the remote-use system 50 may be used jointly so that, for example, a reservation may be confirmed by a restaurant 42 and then an email is sent to the restaurant 42 as a record of the reservation.

Preferably, the remote-use system 50 communicates the diner-input information audibly when the restaurant 42 answers the telephone call. Towards this end, the remote-use system 50 uses text-to-speech software, for instance, so that the person's name is announced, the requested reservation time and date, and the number in the dining party. Additionally, the remote-use system may communicate any other special requests, such as non-smoking.

As another feature of the system and method, the remote-use system 50 may create records 53 that are non-reservation or special records 55. The special record 55 may be communicated from the remote-use system 50 to the restaurant 42, either via telephone call or via the restaurant-use system computer 64. An example of a special record 55 would be where a diner 40 is simply looking for an opportunity to visit the restaurant sometime during a particular week.

In another facet of the system and method, the remote-use system 50 provides the diner 40 with additional functions 70. The diner 40 may log into the remote-use system 50 via the internet and, specifically, into an account that contains the record 53 of their reservation. The diner 40 then has access to the functions 70. One function 70 is an email function 72 so that, upon the diner 40 inputting one or more email addresses of guests, the remote-use system 50 distributes emails to the guests inviting them to join the diner 40 at the restaurant 42 at the particular reservation time. In the event the restaurant 42 was unable to host the specifically desired reservation time and date, the diner 40 may input the actual confirmed reservation time and date to override the default stored as the record 53. The record 53 is then modified to retain the originally requested reservation and the newly input reservation. The email function 72 also provides the guests with a web-type link 74, such as a hypertext transfer protocol link, to the internet website or the microsite of the restaurant 42 hosted by the remote-use system 50, directions to the restaurant 42, information about the area of the restaurant, such as convenient parking, or the restaurant 42 itself, all of which may be stored in the database 52, for instance, and a discount code to purchase dining certificates from the remote-use system 50 website, usable by the diner 40 or designate.

As can be seen, the remote-use system 50 is preferably automated requiring only the actions of the diner 40 and the restaurant 42. As described, the diner 40 logs into the remote-use system 50, such as through the internet, determines which restaurant 42 they would like to make a reservation with, and inputs information to the remote-use system 50. The remote-use system 50 communicates this information to the desired restaurant 42, and allows the restaurant 42 to accept and confirm the request, or to respond with a rejection or non-confirmation. If the restaurant is unwilling or unable to confirm the request, the remote-use system 50 attempts to connect with the diner 40, and then establishes a communications connection between the diner 40 and the restaurant 42 so that a reservation can be discussed and confirmed. The remote-use system 50 also allows the diner 40 to send invitations to anticipated guests, and allows purchasing of dining certificates or coupons, delivered via email to the diner 40.

It should also be noted that the diner telephone 66 and the restaurant telephone 68 may be web-based telephony connections. In this event, the telephones 66, 68 are connected via the internet by the remote-use system 50.

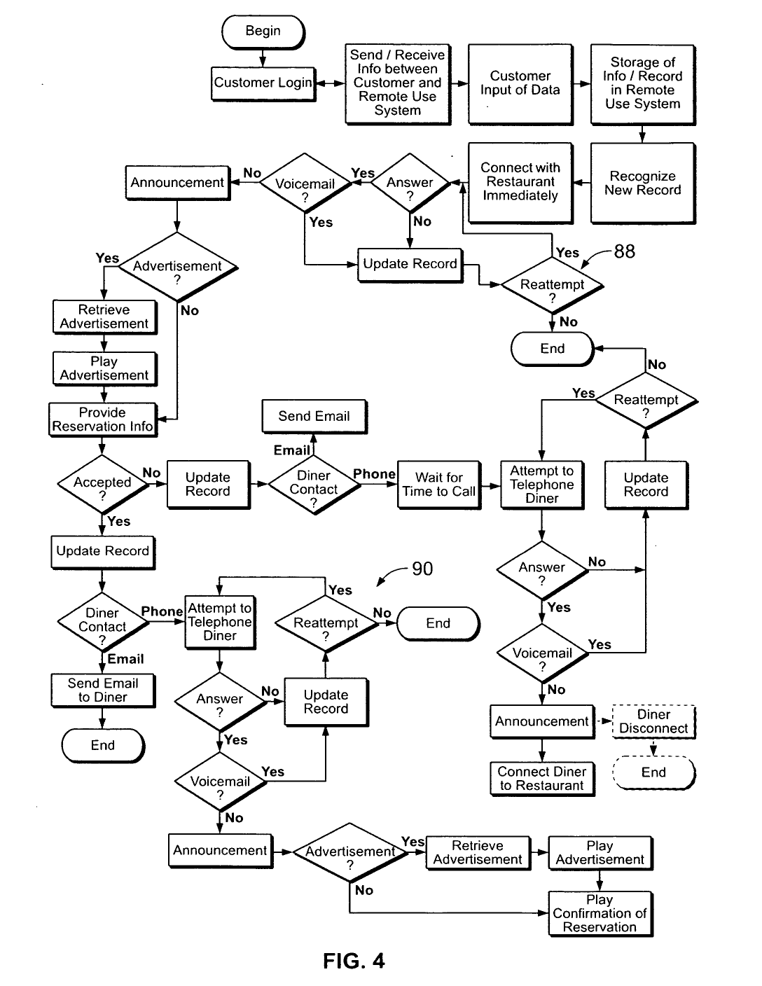

Referring now to FIG. 4, operation of the system and methods described herein can be seen. A customer 12, such as a diner 40, may login to the remote-use system 50 via their personal computer 48. Once a communications connection is established between the diner 40 and the remote-use system 50, information is sent and received between the customer 40 and the remote-use system 50. When a selection for a restaurant 42 has been made, the diner 40 inputs information, such as the time, date, and number of diners for a reservation, and possible a designated time to be contacted by the remote-use system 50, if necessary or beneficial. The remote-use system 50 stores this information as a new record 53, discussed-above in the database 57.

The action function or module 58 surveys the database 57 for new records. Once the new record 53 is recognized, the remote-use system 50 contacts the restaurant 42 by establishing a communications connection therewith, preferably via telephone 68.

The remote-use system 50 makes a determination as to whether the call to the telephone 68 is successful by the telephone 68 answering. If the telephone 68 does not answer, the remote-use system 50 disconnects, updates the record 53 to include the fact that the restaurant 42 did not answer and the reservation was not confirmed. The remote-use system 50 may then re-attempt to establish the connection by calling the telephone 68 again, or may be programmed to wait an additional time period before a re-attempt, represented by decision block 88.

When the telephone 68 answers, the remote-use system 50 first determines whether the telephone 68 has been answered by a voicemail system or box. If the answer is from a voicemail box, the remote-use system 50 disconnects from the telephone 68, updates the record 53 to include the facts that the restaurant 42 was called and a voicemail system answered. The remote-use system 50 may then call again, either immediately or after a pre-programmed time period, again represented by decision block 88.

Once a non-voicemail answer from the telephone 68 is recognized, the remote-use system 50 identifies itself, provides the reservation request information, and prompts the restaurant 42 for a response to the request. If the restaurant 42 response is other than a confirmation, the system 50 attempts to connect the restaurant 42 to the diner 40. Specifically, the remote-use system 50 attempts to connect with the diner 40 through a communications connection. While connecting with the diner 40, the remote-use system 50 decides whether one or more advertisements are to be played to the restaurant 42. If an advertisement is to be played, the remote-use system retrieves the advertisement, and then plays it over the telephone 68 to the restaurant 42. Upon initial connection with the diner 40, the remote-use system 50 preferably plays an announcement to the diner 40 identifying the source of the phone call. A decision is then made by the remote-use system 50 as to whether one or more advertisements are to be played to the diner 40. If an advertisement is to be played, the remote-use system retrieves the advertisement, and then plays it over the telephone 66 to the diner 40. Once an advertisement has concluded, the remote-use system 50 checks to see if proper connections are made with the diner 40 and with the restaurant 42. If, for example, the diner 40 has not answered or been identified as not a voice mailbox, a “hold” message may be played to the restaurant 42, followed by another advertisement.

As noted, the remote-use system 50 attempts to contact the diner 40 after the restaurant 42 has rejected or is otherwise unable to confirm the customer request. In the same manner as when calling the restaurant 42, the remote-use system checks for an answer by the diner 40, then checks for the answer being a non-voicemail answer. If an answer is not initially made, a “hold” message may be played to the restaurant 42 indicating they are continuing to hold while the diner 40 is being contacted, and, generally simultaneously, the remote-use system 50 re-attempts to call the diner 40. If the answer from the diner 40 is a voice mailbox, the remote-use system 50 disconnects from the diner 40 and updates the record 53 to note the failure to properly connect with the diner 40. The remote-use system 50 then decides, at decision block 90, whether an immediate re-attempt should be made to the diner 40, or whether it should wait. If it should wait, the remote-use system 50 plays a disconnect announcement message to the restaurant 42 announcing the inability to connect with the diner 40, and then disconnects from the restaurant 42. The record 53 is updated again, and the remote-use system 50 returns to decision block 88 to determine when and if to attempt to call both the diner 40 and the restaurant 42 again. If, at block 90, the remote-use system should immediately re-attempt to call the restaurant 42, the “hold” announcement is played, the record is updated, and contact is again attempted. It should be noted that, if the remote-use system 50 is to wait a period before re-attempting contact with both the diner 40 and the restaurant 42, either of the diner 40 or restaurant 42 may be contacted first or they may be contacted simultaneously.

Once both the restaurant 42 and the diner 40 are in communication with the remote-use system 50, one or more advertisements may be played to either or both of the parties, or connection announcements may simply be played to both. The restaurant 42 and diner 40 are then connected. The connection is timed and, after a pre-determined period, the remote-use system 50 may cut the connection. It is believed that within a specific amount of time, for instance five minutes, the transaction should be complete. The record is then updated, and the process is ended.

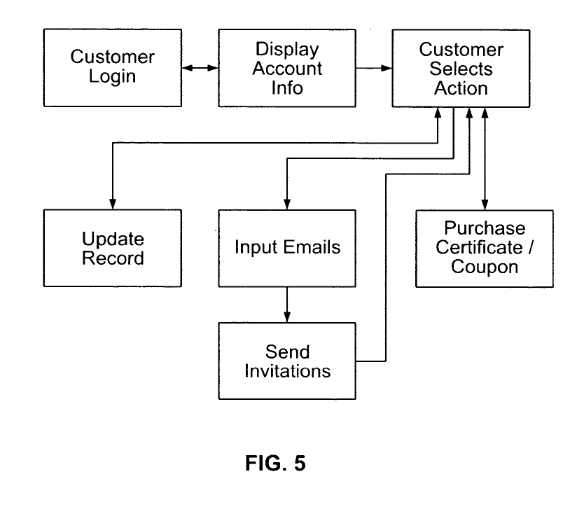

Referring now to FIG. 5, methods of operating the remote-use system 50 are represented. Beginning with a customer, such as a diner 40, logged into the remote-use system 50 and having a confirmed reservation, the diner 40 may use the remote-use system 50 to display the information contained in the record 53. In this manner, the diner 40 can recall the reservation. The diner 40 can then select from a number of activities or actions. For instance, the diner 40 may update the record 53 manually, such as may be necessary if the confirmed reservation differs from the originally selected or requested reservation. The diner 40 may input a guest list consisting of a plurality of email addresses and direct the remote-use system 50 to send invitations. It should be noted that the telephonic capabilities of the remote-use system 50 may be utilized to telephone a guest list of people via inputting a plurality of telephone numbers, and a combination of telephone numbers and email addresses may be provided for a guest list. Additionally, the diner 40 may use the account to purchase certificates or coupons specific to the restaurant 42 for which the reservation is made. These certificates can then be sent to the diner 40, or a guest/designate, via an email address.

In this manner, the diner 40 has access to the benefits and utility of the internet for searching for a restaurant, and can easily request particular time for a reservation. The remote-use system 50 stores the reservation information for ease of retaining the information and for forwarding the information on to other people.

While the invention has been described with respect to specific examples, including presently preferred modes of carrying out the invention, those skilled in the art will appreciate that there are numerous variations and permutations of the above described systems and techniques that fall within the spirit and scope of the invention as set forth in the appended claims.

What is claimed is:

1. A computer implemented system operating under control of a stored program, the system facilitating a relationship between a vendor and a potential customer for the vendor and being located remotely from the vendor and the customer, the program including:
at least one customer communications connection portion permitting the customer to connect to the system, to retrieve data from the system, and to input data to the system including a request;
an information retrieval function portion for collecting information in response to the request by the customer;
an information delivery function portion for sending the collected information to the customer;
an information record function portion for storing information input by the customer;
at least one vendor communications connection portion for connecting to the vendor, and for sending information to the vendor;
a response function portion for receiving from the vendor a response regarding the information sent to the vendor; and
a confirmation function for providing the vendor response to the customer.

2. The system of claim 1 wherein the response function portion includes a prompt function portion providing response instructions and requesting a vendor response in accordance with the response instructions.

3. The system of claim 1 wherein the vendor response includes acceptance of the customer request.

4. The system of claim 3 further including a confirmation function for providing confirmation of acceptance of the customer request by the vendor.

5. The system of claim 4 wherein the confirmation function includes an electronic mail function.

6. The system of claim 4 wherein the confirmation function includes a telephonic function for telephoning the customer to provide confirmation of acceptance.

7. The system of claim 6 wherein the customer input data includes a time to be telephoned, and the telephonic function is operated at the time to be telephoned to provide confirmation of acceptance.

8. The system of claim 1 wherein the vendor response includes rejection of the customer request.

9. The system of claim 8 further including a connection function portion between the customer communications connection and the vendor communications connection allowing the customer to communicate with the vendor, the system connecting the customer and vendor when the vendor response includes rejection of the customer request.

10. The system of claim 9 wherein the customer communications connection portion includes an internet capability permitting the customer to access the system, retrieve data from the system, and input data to the system via the internet.

11. The system of claim 9 wherein the customer communications connection portion further includes a telephonic connection allowing the system to connect with the customer via telephone.

12. The system of claim 9 wherein the customer communications connection portion and the vendor communications connection portion include respective telephonic connection portions, the data input by the customer includes a time to be contacted, and the connection function portion includes a call function portion for calling, via the respective telephonic connection portions, the customer and vendor at the time to be contacted.

13. The system of claim 12 including a message play function portion including an announcement function portion for addressing the customer and the vendor when each is respectively contacted via the telephonic connection portions.

14. The system of claim 12 wherein the message play function portion includes an advertisement function portion for playing advertisements to at least the customer while contacting the vendor via the vendor telephonic connection portion.

15. The system of claim 1 wherein the system further includes a database of information.

16. A method for facilitating arrangement of a reservation between a diner and a restaurant, the method including:
providing a remotely located system;
permitting the customer to access information regarding at least one restaurant via the remotely located system;
sending information regarding at least one restaurant to the customer from the remotely located system;
receiving data including reservation information input by the customer to input data into the remotely located system;
connecting the remotely located system with the restaurant;
communicating the input customer data to the restaurant;
receiving a response to the input customer from the restaurant;
sending a response communication to the customer based on the restaurant response.

17. The method of claim 16 wherein the step of receiving a response include receiving a rejection of the restaurant.

18. The method of claim 17 wherein the step of sending a response communication includes notifying the diner of the restaurant rejection.

19. The method of claim 18 wherein notifying the diner includes emailing a communication to the diner.

20. The method of claim 18 wherein notifying the diner includes telephoning the diner.

21. The method of claim 20 wherein telephoning the diner includes telephoning the restaurant, and includes connecting the diner with the restaurant.

22. The method of claim 16 wherein the customer input data includes a non-reservation request.

23. The method of claim 16 further including playing audio advertisements.
